(19) United States
(12) Patent Application Publication
(10) Pub. No.: US 2005/0249298 A1
(43) Pub. Date: Nov. 10, 2005

(54) Multi-code multi-carrier code division multiple access (CDMA) system and method

(76) Inventors: Taeyoon Kim, Austin, TX (US); Jaeweon Kim, Austin, TX (US); Jeffrey G. Andrews, Austin, TX (US); Theodore S. Rappaport, Austin, TX (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/118,822

(22) Filed: Apr. 28, 2005

Related U.S. Application Data
(60) Provisional application No. 60/565,983, filed on Apr. 28, 2004.

(51) Int. Cl. H04L 27/28

(52) U.S. Cl. 375/260

(57) ABSTRACT

A multi-code multicarrier CDMA system and method for communicating data by transforming a stream of data into a plurality of code sequences selected from a code book by associating symbols of the data stream with the code sequences of the code book, wherein the codebook includes M code sequences and each of the code sequences has a length of N data symbols, copying each of the code sequences onto one or more of a plurality of subcarriers, transmitting the plurality of subcarriers, receiving the plurality of transmitted subcarriers, demodulating the received subcarriers to result in the code sequences, transforming the code sequences back into the stream of data based upon the associations between the code sequences of the code book and the symbols of the data stream, changing at least one of the number M and lengths N of the code sequences in the code book.

This application claims the benefit of U.S. Provisional Application No. 60/565,983, filed Apr. 28, 2004.

### FIELD OF THE INVENTION

The present invention relates to wireless communications, and more particularly to a new multicarrier CDMA system and method.

### BACKGROUND OF THE INVENTION

Future wireless systems such as fourth generation (4G) cellular will need flexibility to provide subscribers with a variety of services such as voice, data, images, and video. Because these services have widely different data rates and traffic profiles, and will respond differently to radio propagation, multiple access interference, and other network layer issues that specifically impact an application or service, future generation wireless networks will have to accommodate a wide variety of data rates. Code division multiple access (CDMA) has proven very successful for large scale cellular voice systems, but there is some skepticism about whether CDMA will be well-suited to non-voice traffic. This has motivated research on multi-code CDMA systems which allow variable data rates by allocating multiple codes, and hence varying degrees of capacity to different users. Meanwhile, multicarrier CDMA (MC-CDMA) has emerged as a powerful alternative to conventional direct sequence CDMA (DS-CDMA) in mobile wireless communications, and has been shown to have superior performance to single carrier CDMA in multipath fading. The following references, the contents of which are incorporated herein by reference, are representative of the prior art in wireless networks and systems, CDMA, and multicarrier communications:
T. S. Rappaport, Wireless communications, principles and practice, 2nd ed. Upper Saddle River, N.J.: Prentice Hall PTR, 2002.
C. L. I and R. D. Gitlin, “Multi-code CDMA wireless personal communications networks,” IEEE International Conference on Communications, pp. 1060-1064, June 1995.
C. L. I, G. P. Pollini, L. Ozarow, and R. D. Gitlin, “Performance of multi-code CDMA wireless personal communications networks,” IEEE Vehicular Technology Conference, vol. 2, pp. 907-911, July 1995.
H. D. Schotten, H. Elders-Boll, and A. Busboom, “Multi-code CDMA with variable sequence-sets,” IEEE International Conference on Universal Personal Communications, pp. 628-631, October 1997.
S. Hara and R. Prasad, “Overview of multicarrier CDMA,” IEEE Communications Magazine, vol. 35, pp. 126-133, December 1997.
X. Gui and T. S. Ng, “Performance of asynchronous orthogonal multicarrier CDMA system in a frequency selective fading channel,” IEEE Transactions on Communications, vol. 47, no. 7, pp. 1084-1091, July 1999.
E. A. Sourour and M. Makagawa, “Performance of orthogonal multicarrier CDMA in a multipath fading channel,” IEEE Transactions on Communications, vol. 44, no. 3, pp. 356-367, March 1996.
N. Yee, J-P. Linnartz and G. Fettweis, “Multi-carrier CDMA in indoor wireless radio networks,” International Symposium on Personal, Indoor, and Mobile Radio Communications, pp. 109-113, September 1993.
J. G. Andrews and T. H. Meng, “Performance of multicarrier CDMA with successive interference cancellation in a multipath fading channel,” IEEE Transactions on Communications, vol. 52, pp. 811-822, May 2004.
L. L. Yang and L. Hanzo, “Multicarrier DS-CDMA: a multiple access scheme for ubiquitous broadband wireless communications,” IEEE Communications Magazine, vol. 41, pp. 116-124, October 2003.
T. Ottosson and A. Svensson, “Multi-rate schemes in DS/CDMA systems,” IEEE Vehicular Technology Conference, pp. 1006-1010, January 1995.
U. Mitra, “Comparison of maximum-likelihood-based detection for two multi-rate access schemes for CDMA signals,” IEEE Transactions on Communications, vol. 47, pp. 64-67, January 1999.
3GPP2, S. R0023, “High speed data enhancement for CDMA2000 1×-data only,” June 2000.
“Technical overview of 1×EV-DV,” White paper, Motorola Inc., September 2002, version G1.4. [Online]. Available: http://www.cdg.org
P. Bender, P. Black, M. Grob, R. Padovani, N. Sindhushayana, and A. Viterbi, “CDMA/HDR: a bandwidth-efficient high-speed wireless data service for nomadic users,” IEEE Communications Magazine, vol. 38, pp. 70-77, July 2000.
H. D. Schotten, H. Elders-Boll, and A. Busboom, “Adaptive multi-rate multi-code CDMA systems,” IEEE Vehicular Technology Conference, pp. 782-785, May 1998.
P. W. Fu and K. C. Chen, “Multi-rate MC-DS-CDMA with multi user detections for wireless multimedia communications,” IEEE Vehicular Technology Conference, vol. 3, pp. 1536-1540, May 2002.
Y. W. Cao, C. C. Ko, and T. T. Tjhung, “A new multi-code/multicarrier DS-CDMA System,” IEEE Global Telecommunications Conference, vol. 1, pp. 543-546, November 2001.
P. W. Fu and K. C. Chen, “Multi-rate multi-carrier CDMA with multiuser detection for wireless multimedia communications,” Wireless Communications and Networking Conference, vol. 1, pp. 385-390, March 2003.
T. Kim, J. Kim, J. G. Andrews, and T. S. Rappaport, \Multi-code Multicarrier CDMA: Performance Analysis”, IEEE Intl. Conf on Communications, Paris, France, pp. 973-77, June 2004.
J. G. Andrews, “Interference Cancellation for Cellular Systems: A Contemporary Overview”, IEEE Wireless Communications Magazine, pp. 19-29, April 2005.
J. G. Proakis, Digital communications, 4th ed. New York, N.Y.: McGraw-Hill, 2001.

### SUMMARY OF THE INVENTION

The present invention is a multi-code multicarrier code division multiple access (MC-MC-CDMA) system and method for use in wired and wireless communication systems or networks. The system and method achieves spreading gain in both the time and frequency domains, where the spreading gain in time is dynamically changed to better address the needs of the system and/or system users.

The method of the present invention is a method of communicating data that includes transforming a stream of data into a plurality of code sequences selected from a code book by associating symbols of the data stream with the code sequences of the code book, wherein the codebook includes M code sequences and each of the code sequences has a length of N data symbols, copying each of the code sequences onto one or more of a plurality of subcarriers, transmitting the plurality of subcarriers, receiving the plurality of transmitted subcarriers, demodulating the received subcarriers to result in the code sequences, transforming the code sequences back into the stream of data based upon the associations between the code sequences of the code book and the symbols of the data stream, and changing at least one of the number M and lengths N of the code sequences in the code book.

Another aspect of the present invention is a communications system that includes an encoder for transforming a stream of data into a plurality of code sequences selected from a code book by associating symbols of the data stream with the code sequences of the code book, wherein the codebook includes M code sequences and each of the code sequences has a length of N data symbols, a copier for copying each of the code sequences onto one or more of a plurality of subcarriers, a transmit unit for transmitting the plurality of subcarriers, a receiver unit for receiving the plurality of transmitted subcarriers and demodulating the received subcarriers to result in the code sequences, and a detector unit for transforming the code sequences back into the stream of data based upon the associations between the code sequences of the code book and the symbols of the data stream, wherein at least one of the number M and lengths N of the code sequences in the code book used by the encoder and the detector unit are changed.

Other objects and features of the present invention will become apparent by a review of the specification, claims and appended figures.

### BRIEF DESCRIPTION OF THE DRAWINGS

FIG. 1 shows a simplified block diagram of the transmitter for the system and method of the present invention.

FIG. 2 shows the receiver for the same system and method.

FIG. 3 shows the BER performance versus SNR comparing the disclosed MC-MC-CDMA approach for various codebook sizes with prior art MC-CDMA and multi-code single-carrier CDMA (MC-SC-CDMA) systems. All the systems occupy the same total bandwidth, and the MC-MC-CDMA system uses orthogonal code sequences since M is less or equal to N.

FIG. 4 shows the BER versus the number of users for the MC-CDMA system and the disclosed MC-MC-CDMA system. For the same total bandwidth, the MC-MC-CDMA can support a much higher system capacity than a conventional CDMA system.

FIGS. 5A-D shows the received (pre-despreading) SINR versus the size of the codebook M with various number of users K and Signal to Noise Ratios (SNR). It can be seen that the value of M does not change the received SINR.

### DETAILED DESCRIPTION OF THE PREFERRED EMBODIMENTS

A novel multi-code multicarrier code division multiple access (MC-MC-CDMA) system and method is disclosed here for use in a wireless communication system or network, using wireless channels between one or more wireless devices. The channels may include channels that are frequency selective. By allowing each user (e.g. each wireless device or transmitter or transceiver) to transmit an M-ary code sequence, the MC-MC-CDMA system described herein can support various data rates (e.g. end user bandwidths, throughputs, throughput rates, or data traffic rates), as will be required for evolving wireless applications and standards. The technique achieves spreading gain in both the time and frequency domains. It has been shown that the bit error rate of the technique can be analytically derived in frequency selective fading, with Gaussian noise and multiple access interference, and analysis shows that the novel MC-MC-CDMA system and method clearly outperforms both single-code multicarrier CDMA (MC-CDMA) and single-carrier multi-code CDMA in a fixed bandwidth allocation (e.g. such as a spectrum allocation given by the FCC or some other national or international spectrum regulatory body). This indicates that MC-MC-CDMA may provide improved performance in allocated frequency bands of a finite bandwidth (e.g. channel assignment or frequency allocation).

The new multiple access and modulation technique of the present invention combines multi-code multicarrier CDMA systems for exploiting the best aspects of each of these earlier systems. Multi-rate transmission for single-carrier CDMA systems in AWGN channels has been previously considered. Wireless networks such as Wi-Fi, WiMax, Wireless L:ANS, public safety, and third generation cellular standards, namely CDMA2000 1×EV-DO and 1×EV-DV, known sometimes as HDR, supports diverse data rates using many codes with different spreading factors. However, in the case of prior CDMA standards, the code assignment is limited by the number of orthogonal codes for the short spreading factor, and multipath can be very problematic for the higher data rates since the spreading factor is short. Unlike the HDR system, the apparatus and method of the present invention does not require variable spreading factors. It uses the same code book to support various data rates for different users.

Multi-code techniques such as the present invention trade off the number of supportable subscribers with the “per subscriber” data rate. Said another way, the number of simultaneous higher data rate users in a multi-code CDMA system will be less than the number of equal data rate users in a traditional CDMA system. A variation of the multi-code scheme, which supports variable data rates by varying the set of code sequences assigned to each of the users, has been proposed. The users communicate their data by choosing one sequence from their code set to transmit over the common channel. Also, the performance of multi-code CDMA was considered only in an AWGN channel.

There have been previous disclosures on multi-rate transmission for multicarrier direct sequence CDMA (MC-DS-CDMA) systems. In multi-rate MC-DS-CDMA, the data stream of a user with data rate is first multiplexed into different serial streams with a base data rate, and each serial stream is treated as an individual user. Each of the serial streams is then converted into parallel sub-streams and spread by the same spreading code with a constant spreading factor. Moreover, such a system would have more interference per user, because each of the data streams is treated as an independent user. Therefore, such a system experiences more interference as the data rate increases, even with a fixed number of users. Also, multi-rate transmission for frequency spread multicarrier CDMA has been studied. In such a multi-rate multicarrier CDMA system, the subcarriers are divided into groups according to the required data rate. Therefore, when the number of subcarriers is fixed, the spreading gain in frequency domain for each data is decreased with increasing data rate. A single-carrier multi-code CDMA system has been disclosed that addresses this interference scaling problem by using just one code sequence instead of spreading each of the multiplexed data streams so that the interference does not increase linearly with the data rate. However, such a system does not achieve the frequency diversity benefits of multicarrier modulation.

In contrast, the present invention is a new multicarrier CDMA method and system with multi-code that outperforms single-carrier multi-code and multi-rate multicarrier direct sequence system. The multi-code multicarrier CDMA (MC-MC-CDMA) system achieves the advantages of both previous MC-CDMA systems mentioned above: (i) variable data rates without interference scaling and (ii) enhanced robustness to multipath fading channels. Moreover, the present approach has both time and frequency spreading gain to exploit the diversity and interference averaging properties of multicarrier modulation and CDMA.

The present invention uses a set of codes (i.e. a “codebook”) containing a plurality of codes (also called “code sequences” and “codewords”) for each user of the network. The code sequences are used to send the underlying data instead of sending the underlying data itself to expand the length (and therefore the time to send) the transmitted data (i.e. time spreading). To maximize performance, each code of the codebook can be chosen to maximize the Euclidean distance between all other codes of the codebook. A particular transmitter and receiver may share a particular codebook, and different users or wireless devices in the network may have their own separate codebooks, or they may too share the particular codebook. Furthermore, the possible codes for a particular transmitter-receiver connection are obtained from the codebook in use for that particular pair. This can be done in a real-time manner, a static, random, or periodic manner, and may be implemented in many ways well known to those skilled in the art. For example, the codebook may be stored in memory within a wireless device and codewords selected from a look-up table or tabulated listing in memory for possible codewords that are stored, transmitted, or periodically or randomly updated, depending on the desired data rate of a particular user in the network, or alternatively, by the number of users or the particular conditions in the network. The codebook may be transmitted over the air, loaded by magnetic, optical or SIM media, downloaded from the internet, or some other means by which information may be transferred into a portable device. It is clear that the codewords and codebook could be recreated by a local processing mechanism or storage mechanism, so that over the air or remote programming of a codebook could use less bandwidth and be more compact in nature in order to implement the codewords or codebook at a user device.

According to the present invention, the codebook used to send any given data stream of symbols is preferably dynamically changeable to adapt to the varying needs of the user and/or the system. For example, depending on factors such as desired transmission power, desired interference tolerance, or desired allocated bandwidth for the particular user, one of several different codewords of varying length can be selected to send a particular data stream of symbols. Changing the codewords or codebook associated with any given data stream provides a tremendous advantage over systems using static codewords for transmitted data sets. As the above factors (power, interference tolerance, bandwidth) change, so too can the amount of time spreading (i.e. dynamic time spreading). Thus, some of the data can be transmitted using codewords before the codebook is changed, and some of the data can be transmitted using codewords after the codebook is change.

The codebook has a plurality of code sequences each comprised of a plurality of data symbols. The number of codes in the codebook is represented by M, and the length of the codes in the codebook is represented by N. While the preferred implementation of the present invention uses a codebook where all the code therein have the same length, it is within the scope of the present invention to utilize a codebook with codes having lengths that vary from each other. Dynamically changing the codebook can be performed in two ways: 1) change the number (M) of codes in the codebook, and 2) change the length (N) of the codes in the codebook. Either changing M or N, or changing both M and N, effectuates the dynamic time spreading of the present invention.

The on-going sensing of the network or the particular sensing which instructs a transmitter and receiver pair to implement a particular codebook or codeword or to implement a particular data rate may be performed by a particular user's device, by a base station or network controller, by a protocol or standard, or by some embedded or remote monitoring device that receives RF transmissions from one or more transmitters in the network, where it is understood that channel conditions, interference, BER, SNR, signal, opening of an eye, or some other well known receiver detection characteristic, or alternatively, the requirement of the particular application for a particular data rate, dictates the instruction.

The codebook used at any instant of time compared with another instant of time may actually be different, so long as at least one transmitter and receiver have knowledge of the particular codebook to be used. Thus, one may envision the present invention of being a continuously “smart” or a dynamically improved way of allocating throughput and bandwidth, or dictating performance that meets a need but is not wasteful of resources, between a transmitter and receiver by creating a codebook that is adaptable, and that further allows the codewords used from the codebook to be optimized to provide highest performance, such as improved throughput, Bit Error Rate, Packet Error Rate, minimized transmitter power, or spectral efficiency. The adaptive codebook essentially creates a finite number of possible time spreading sequences (codewords) that may be used in transmission between a transmitter and receiver to robustly achieve improved performance and/or variable data rates.

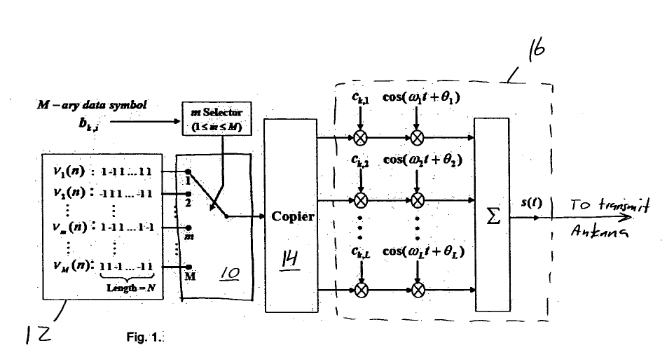

FIG. 1 shows a simplified block diagram of the transmitter for the system. As one skilled in the art would recognize, this diagram pertains to incoming data symbols b_{k,i} for user k at time i. This symbol, representing log₂M bits of information, is transformed into a length N sequence by an encoder 10. The sequence could have symbols which are binary or have larger cardinality. The encoder implements the transformation using the codebook 12 such that for each data symbol into the encoder 10, a sequence of N data symbols is produced at the output. This encoder could be static, dynamic, or adaptive, where the particular codebook and/or the codes in the codebook being utilized is/are changing over time as discussed previously, and may be implemented in software, FPGA, as a dedicated integrated circuit, or could be part of a circuit or software or implemented as part of a software radio or operating system. As shown in FIG. 1, this length N sequence is then copied onto each of L orthogonal subcarriers by copier 14. In practice, this is generally implemented using an Inverse Fast Fourier Transform, as in OFDM systems described in the prior art. In contrast to OFDM, each subcarrier preferably carries redundant information that is then multiplied by a user specific code c_{k,1} as is often done in MC-CDMA, and the aggregation of the L subcarriers is then transmitted by the system antenna after appropriate D/A conversion and RF modulation by the transmit unit 16, as is well known to those skilled in the art of communications system design and engineering. It is possible, to limit the number of subcarriers used (to reduce redundancy), even down to a single subcarrier.

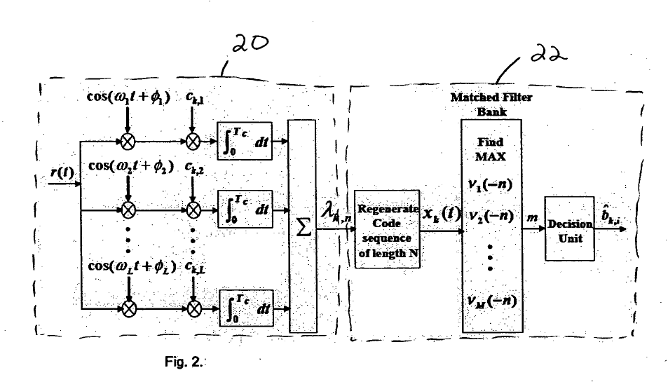

FIG. 2 shows the receiver for the same system. The received signal r(t), which in general will consist of the sum of K (interfering) signals, is processed by a receiver synchronized specifically to one of the K users. This receiver could take on a variety of alternate forms (such as a RAKE receiver, a software radio, or multiuser detectors), but FIG. 2 depicts the simplest such receiver unit 20 known as a correlator receiver or equivalently, a matched filter. This receiver unit 20 demodulates each subcarrier, generally using a Fast Fourier Transform, and correlates each subcarrier with the appropriate code sequence, as is well known in the art for CDMA receivers. The correlator outputs of each branch are combined in some manner, which includes equal gain, maximal ratio, selection combining, or some other means, to produce estimates of each of the N bits of the original length N transmitter sequence. In an ideal system having no noise or interference, the N length data symbols are transformed back into the original data stream b_{k,i} using the codebook (i.e. as a look up table) by a detector unit 22. In reality, the N length data symbols will not exactly match the codebook entries due to noise and interference, and thus the detector unit 22 is preferably a minimum distance detector that is well known in the art. This detector can be implemented in software, hardware, or firmware. The detector compares the estimated length N sequence with the M candidates, and chooses the best one, generally by minimizing the Euclidian distance between the estimated waveform and the M candidates, which is done by computing the mean squared distance between the estimated length N codeword and all of the M candidate length N codewords, and choosing the one codeword corresponding to the minimum mean squared distance relative to the estimated received waveform. The selected codeword then can be easily mapped to the log₂M bits of transmitted information, i.e. b_{k,i}. Such minimum distance detectors and symbol mappers may be implemented in many ways as known to those skilled in the art, and may use any combination of hardware, software, or firmware.

The presently disclosed MC-MC-CDMA method and system uses a set of M codes called the code sequence set for M-ary modulation. These M codes are chosen to maximize the Euclidian distance between them (for a specified transmit energy), since this will allow the probability of error to be minimized. If M is less than or equal to N, then they can all be chosen to be orthogonal to one another, for example by letting the sequences vₘ(n) be orthogonal Walsh-Hadamard codes. If M is greater than N, then the number of orthogonal dimensions is N, so not all M symbols can be orthogonal. In this case, a variety of methods can be used to select good code symbols within the general design guideline that they have good Euclidian separation. Although focus is on the orthogonal case, the analysis is not confined to this case.

It should be noted that each user has the same code sequence set vₘ(n) which represents an information data symbol of log2 M bits. The size of the code sequence set depends on the required data rate. In the usual CDMA case, the size of the code sequence set is 2, i.e. there are two sequences in the set, one to represent a ‘0’ and the other to represent a ‘1’. In the disclosed system, each user has a set of M code sequences, where log₂M is the ratio of the required data rate to the base data rate (1 bit/symbol). Therefore, if the data rate is to be made log2 M times the base data rate, the size of the code sequence set is M and each M-ary data symbol is mapped to one of the code sequences of length N. This code length N is fixed over all different values of M. Thus, varying the data rate does not change the code length N, but it does change the size of the code sequence set M. If orthogonal code sequences are used, the performance advantages of orthogonal modulation are attained. However, in order to maintain linear independence between the code sets, it is required that M is less or equal to N. If non-orthogonal code sequences are used, then M can be greater than N, naturally at the expense of the distance between code symbols.

An M-ary symbol selects one of M pre-mapped code sequences for transmission. Each code sequence has a time domain spreading ratio of N. Each bit of the length N code sequence is copied onto the L subcarrier branches and multiplied with the user-specific scrambling code of the corresponding branch. The user-specific codes are independent of time so that the spreading at this stage is only in frequency, allowing users to choose specific codes that have low cross-correlations with other user's codes. Each of these branches then modulates one of the L orthogonal subcarriers and the results are summed. As in popular orthogonal frequency division multiplexing (OFDM), this process can be implemented using a size L Inverse Fast Fourier Transform (IFFT) to replace the subcarrier multiplication and summation. Unlike OFDM, which uses serial to parallel conversion, in multicarrier CDMA the same information bit is replicated on all subcarriers to achieve a spreading gain for multiple access. Also, a cyclic prefix is not typically employed in multicarrier CDMA because self-ISI is a minor effect compared to multiple access interference.

A multicarrier CDMA system with spreading only in the frequency domain is generally referred to as an MC-CDMA system, while a multicarrier system with spreading only in the time domain is usually called MC-DS-CDMA. The MC-MC-CDMA system of the present invention has two-dimensional spreading gain in both the time and frequency domains by using a multi-code signal and multicarrier modulation, respectively. Two-dimensional spreading exploits both time and frequency diversity and thus can simultaneously combat frequency selective fading and multiple-access interference (MAI) from the advantages of multicarrier modulation and CDMA. FIGS. 1 and 2 illustrate how these elements are combined according to the present invention.

The total spreading gain with two-dimensional spreading is the product of the time spreading gain and the frequency spreading gain. Within a fixed total bandwidth, time and frequency spreading gain can be adapted to the user load and radio link conditions such as Doppler spread, delay spread, and channel gain. MC-MC-CDMA improves upon MC-DS-CDMA in its handling of variable rates, and more efficient spreading codes. The latter property is due to the selection of one of M information-bearing codewords rather than multiplying a fixed codeword by the incoming data bit.

Referring to FIG. 1, each user's M-ary data symbol is mapped to one of the code sequences of length N in a code sequence set according to pre-defined one-to-one matching. The selected code sequence is transmitted by using MC-CDMA system transmitter, as described previously. In the receiver, after RF demodulation and A/D conversion, an FFT is applied to the baseband signal, as shown in FIG. 2 and described previously. This implementation could be in any combination of hardware of software, historically the RF demodulation and A/D conversion is done by dedicated integrated circuitry and the baseband operations by ASICs or DSP, although software radios are becoming increasingly practical. The output of the FFT is then de-spread to generate each bit of the received code sequence. The N regenerated bits compose one code sequence, and the regenerated code is the input of the matched filter bank to detect the transmitted symbol. The N de-spread bits form a degenerated code sequence, which is correlated with each of the possible M code sequences. The sequence that gives maximum correlation is then mapped back into an M-ary symbol. Thus, performance of the proposed MC-MC-CDMA system depends on the characteristic of the code sequence such as orthogonality between code sequences. The use of this narrowband multicarrier scheme provides frequency diversity for multipath mitigation so that no RAKE receiver is required, and a greater percentage of the received energy is actually collected for detection.

As described above, and as shown in FIGS. 1 and 2, the MC-MC-CDMA method and system may be implemented in a particular way. However, it is clear to one skilled in the art that alternate embodiments are possible while preserving the essence of the techniques, and are quite likely to be useful in particular applications or scenarios. For example, although the technique was developed primarily with view to a CDMA cellular system, it is applicable in both the uplink and downlink, and may be used in a broadcast, local or personal area network. In the downlink, different code sequences c_{k,1} are practical than in the uplink, usually, due to the synchronous nature of the downlink and the asynchronous nature of the uplink. In addition to CDMA cellular systems, this scheme, because of its multicarrier core, can be applied to OFDM systems as well in order to provide interference robustness. The disclosed modulation and codebook scheme is also applicable to mesh, point-to-point, point-to-multipoint, or ad hoc wireless networks, sensor networks, or even wireline or fiber optic systems. As mentioned previously, a plethora of different receiver options are viable for implementing the proposed MC-MC-CDMA system, including interference canceling receivers, multi-user detectors, and so on. This system could also be implemented on multi-antenna (MIMO) systems to obtain further data rate or diversity gains.

The numerical bit error rate (BER) performance of the disclosed invention is now compared to prior art approaches, and some properties of MC-MC-CDMA are observed. For the MC-MC-CDMA system, the chosen parameters are N=16 for the length of the code sequence, L=16 for the number of subcarriers, and M=2, 4, 8, 16 for the M-ary symbols. It is clear that other values and parameters may be contemplated, and this disclosure and the examples in this disclosure are not meant to limit in any way the practice and scope of the invention.

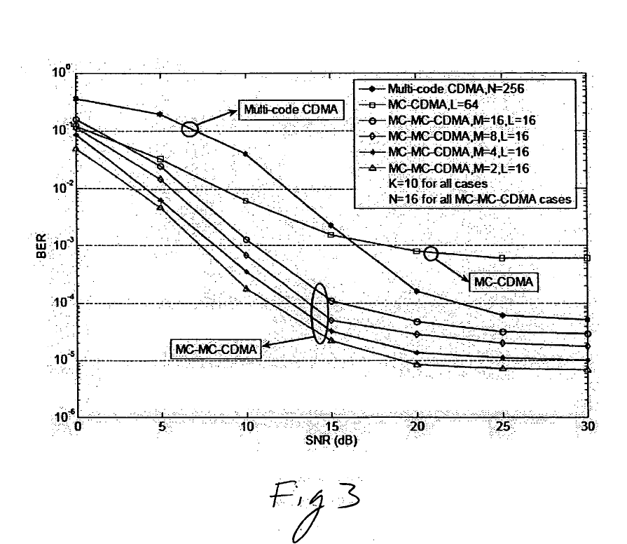

FIG. 3 shows the BER performance of the MC-MC-CDMA system with various M, the MC-CDMA system, and the multi-code single-carrier CDMA (MC-SC-CDMA) system. In order to fairly compare the BER performance of MC-MC-CDMA, MC-CDMA and CDMA (MC-SC-CDMA) systems, where these systems have different subcarrier channel bandwidths, the number of subcarriers in each system is fixed to make the total bandwidth equal for all three systems. For example, when the length of the code sequence N=M=16, the MC-MC-CDMA system transmits 16 bits within one symbol time (4 information bits). That means the MC-MC-CDMA system uses 4 times more bandwidth compared to an MC-CDMA system with the same data rate. Therefore, 16 subcarriers are used for the MC-MC-CDMA system and 64 subcarriers for the MC-CDMA system. For the MC-SC-CDMA system, the length of the code sequence is 256. In this way, all three systems use the same total bandwidth in the simulation. As can be seen, even though the MC-CDMA system can get better frequency diversity by using more subcarriers, the proposed MC-MC-CDMA system performs better. By using multicarrier modulation, the MC-MC-CDMA system also easily outperforms the MC-SC-CDMA system in a frequency selective fading channel. Due to the time and frequency spreading gain and orthogonality between code sequences, the proposed MC-MC-CDMA system shows better performance than MC-CDMA and MC-SC-CDMA systems. The performance can be adjusted to different channel conditions, since the time-frequency spreading tradeoff can be controlled accordingly. Additionally, due to the proposed maximum distance symbol encoder, it outperforms the two previously proposed multi-rate MC-CDMA systems.

The various parameters shown by way of example herein are not meant to be limiting, and the Rayleigh fading assumption is a particular channel condition due to particular multipath structures and also related to the bandwidth of a transmitted signal, and this analysis is not meant to limit the present disclosure in any way. For example, the disclosed invention may work in other channel fading conditions, such as Ricean, Log-normal, or static (stationary channels), or other types of time or frequency varying channel conditions either known now or in the future. By way of example, if M=2 or 16, and K=10, the performance is better for M=2, because the 16ary MC-MC-CDMA system uses more code sequences than the binary MC-MC-CDMA system. In the same N=16 dimensional signal space, it results in a smaller distance between code sequences than for the M=2 case. The plot shows that the analytical derivations agree closely with the simulation results for the orthogonal code sequence case.

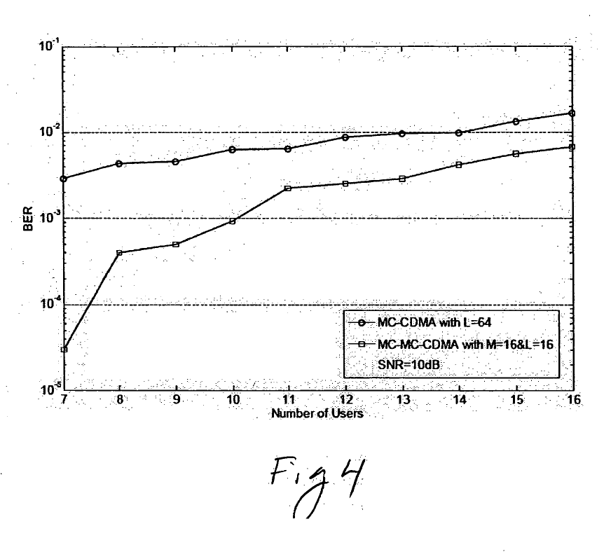

The BER performance versus the number of users for both systems with an SNR of 10 dB is shown in FIG. 4. At the same BER, data rate per user, and consumed bandwidth, the MC-MC-CDMA system can support more users than the MC-CDMA system. For example, at a BER of 3×10⁻³, the number of users supported by the MC-MC-CDMA system is about 13, while it is about 7 for the MC-CDMA system. These are both uncoded systems with a total spreading gain of 64.

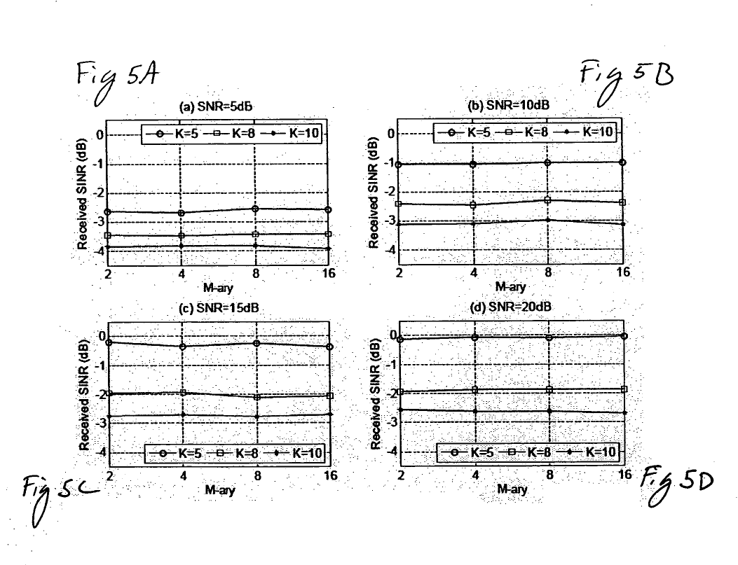

FIG. 5 shows the received (pre-despreading) signal-to-interference-plus-noise ratio (SINR) versus M with various numbers of users K and SNR. In this system, the mean of all interference power is assumed to be equal. As shown in FIG. 5, the received SINR of the MC-MC-CDMA system varies according to the variation of K and SNR, but not M. Since the length of the code sequence N is fixed over all different value of M, the received SINR is not changed according to M as shown in FIG. 5. It means that the MC-MC-CDMA system of the present invention can support higher data rate without increasing the interference unlike the multi-rate multicarrier CDMA system.

It should be apparent that the multi-code multicarrier CDMA of the present invention supports variable data rates for a large number of users ideal for wireless networks and systems. By using the multi-code concept, and by exploiting the MC-MC-CDMA system, two-dimensional spreading gain as well as frequency diversity is achieved. In addition, various data rates can easily be supported by changing the size of the code sequence set. With the same total bandwidth, both analytical and simulation results showed that the presently disclosed MC-MC-CDMA system clearly outperforms prior art multicarrier CDMA and single carrier multi-code CDMA in terms of bit error probability and user capacity. This shows that data rate flexibility can be achieved in a multicarrier CDMA system without any sacrifice in performance, and to the contrary, can actually allow improved robustness, flexibility, and capacity.

It is to be understood that the present invention is not limited to the embodiment(s) described above and illustrated herein, but encompasses any and all variations falling within the scope of the appended claims.

1. A method of communicating data, comprising:
transforming a stream of data into a plurality of code sequences selected from a code book by associating symbols of the data stream with the code sequences of the code book, wherein the codebook includes M code sequences and each of the code sequences has a length of N data symbols;
copying each of the code sequences onto one or more of a plurality of subcarriers;
transmitting the plurality of subcarriers;
receiving the plurality of transmitted subcarriers;
demodulating the received subcarriers to result in the code sequences;
transforming the code sequences back into the stream of data based upon the associations between the code sequences of the code book and the symbols of the data stream; and
changing at least one of the number M and lengths N of the code sequences in the code book.

2. The method of claim 1, wherein the change of at least one of the number M and lengths N modifies at least one of the number of code sequences associated with the stream of data and the lengths of the code sequences transmitted and received.

3. The method of claim 1, wherein at least one of the code sequences in the code book has a value of length N that is different from that of another one of the code sequences in the code book.

4. The method of claim 1, wherein all of the code sequences in the code book have a value of length N that is the same.

5. The method of claim 1, wherein at least part of the data stream is transmitted and received before the change of at least one of the number M and length N, and at least another part of the data stream is transmitted after the change of at least one of the number M and length N.

6. The method of claim 1, wherein the transmitting and the receiving are performed in a wireless manner.

7. The method of claim 1, wherein the change of at least one of the number M and length N includes changing the number M of the code sequences in the code book.

8. The method of claim 1, wherein the change of at least one of the number M and length N includes changing the length N of the code sequences in the code book.

9. The method of claim 1, wherein the change of at least one of the number M and length N includes changing both the number M and the length N of the code sequences in the code book.

10. The method of claim 1, wherein the transforming of the code sequences back into the stream of data includes using a minimum distance detector.

11. The method of claim 1, wherein the code sequences in the code book are orthogonal Walsh-Hadamard code sequences.

12. The method of claim 1, wherein the copying of each of the code sequences includes copying each of the code sequences onto all the plurality of subcarriers.

13. A communications system, comprising:
an encoder for transforming a stream of data into a plurality of code sequences selected from a code book by associating symbols of the data stream with the code sequences of the code book, wherein the codebook includes M code sequences and each of the code sequences has a length of N data symbols;
a copier for copying each of the code sequences onto one or more of a plurality of subcarriers;
a transmit unit for transmitting the plurality of subcarriers;
a receiver unit for receiving the plurality of transmitted subcarriers and demodulating the received subcarriers to result in the code sequences; and
a detector unit for transforming the code sequences back into the stream of data based upon the associations between the code sequences of the code book and the symbols of the data stream;
wherein at least one of the number M and lengths N of the code sequences in the code book used by the encoder and the detector unit are changed.

14. The system of claim 13, wherein the change of at least one of the number M and lengths N modifies at least one of the number of code sequences associated with the stream of data and the lengths of the code sequences transmitted and received.

15. The system of claim 13, wherein at least one of the code sequences in the code book has a value of length N that is different from that of another one of the code sequences in the code book.

16. The system of claim 13, wherein all of the code sequences in the code book have a value of length N that is the same.

17. The system of claim 13, wherein the communications system dynamically changes the at least one of the number M and length N after part but not all of the data stream is transformed into the plurality of code sequences by the encoder.

18. The system of claim 13, wherein the transmitter unit transmits, and the receiver unit receives, the subcarriers in a wireless manner.

19. The system of claim 13, wherein the change of at least one of the number M and length N includes changing the number M of the code sequences in the code book.

20. The system of claim 13, wherein the change of at least one of the number M and length N includes changing the length N of the code sequences in the code book.

21. The system of claim 13, wherein the change of at least one of the number M and length N includes changing both the number M and the length N of the code sequences in the code book.

22. The system of claim 13, wherein the detector unit includes a minimum distance detector.

23. The system of claim 13, wherein the code sequences in the code book are orthogonal Walsh-Hadamard code sequences.

24. The system of claim 13, wherein the copier copies each of the code sequences onto all the plurality of subcarriers.
